(19) United States
(12) Patent Application Publication
(10) Pub. No.: US 2004/0195821 A1
(43) Pub. Date: Oct. 7, 2004

(54) Multi-use file folder construction

(76) Inventor: Gina S. Ghent, Bronxville, NY (US)

Correspondence Address: STURM & FIX LLP, 206 SIXTH AVENUE, SUITE 1213, DES MOINES, IA, 50309-4076, US

(21) Appl. No.: 10/408,683

(22) Filed: Apr. 7, 2003

(51) Int. Cl. B42F 21/00

(52) U.S. Cl. 283/37

(57) ABSTRACT

A multi-use file folder construction (10) including a single sheet of material (20) such as heavy bond paper stock (21) provided with an offset crease line (22) to form a front file face (23) and an enlarged rear file face (24) wherein, the upper end (24′) of the rear file face (24) is provided with a transverse horizontal perforated line (26) which is intersected by either truncated vertical perforation liens (25′) or truncated vertical slits (25) that form a plurality of detachable tab elements (27) on the upper end (24′) of the rear file face (24).

### CROSS REFERENCE TO RELATED APPLICATIONS

Not applicable.

### BACKGROUND OF THE INVENTION

1. Field of the Invention

The present invention relates to the field of tabbed file folders in general and in particular to a multi-use file folder construction provided with detachable file folder tabs.

2. Description of Related Art

As can be seen by reference to the following U.S. Pat. Nos. 6,138,900; 5,639,124; 5,626,368; 5,447,334, and, 3,643,363, the prior art is replete with myriad and diverse re-usable file folder and file tabbing construction.

While all of the aforementioned prior art constructions are more than adequate for the basic purpose and function for which they have been specifically designed, they are uniformly deficient with respect to their failure to provide a simple, efficient, and practical low cost multi-use file folder construction fabricated from a single sheet of material and provided with a plurality of integrally formed detachable tabs wherein, each tab is dedicated to a particular file content which is selectively assigned by the user.

As most office workers are well aware, the vast majority of file folder constructions are wasteful of natural resources in that they have an unnaturally abbreviated useful life, the span of which is predicated on the length of time that the contents of the file folder are accurately represented by the legend printed on the identifying tab employed on the file folder.

As a consequence of the foregoing situation, there has existed a longstanding need for a new and improved multi-use file folder construction that employs a plurality of detachable tabs wherein, each tab identifies a different file content; and, the provision of such a construction is the stated objective of the present invention.

### BRIEF SUMMARY OF THE INVENTION

Briefly stated, the multi-use file folder construction that forms the basis of the present invention comprises in general a single sheet of heavy bond paper that is provided with an offset crease line that creates a front, generally rectangular file face and an enlarged generally rectangular rear file face the upper end of which projects a selected distance above the upper end of the front file face when the front and rear file faces are disposed in their folded position.

In addition, the upper end of the rear file face is provided with a plurality of equally spaced vertical slits to form a plurality of tab elements that are formed integrally with the remainder of the original sheet of material wherein, the depth of each of the slits is the same and a horizontal line of perforations extends across the upper end of the rear file face to permit the tab elements to be selectively removed from the rear file face, as will be explained in greater detail further on in the specification.

### BRIEF DESCRIPTION OF THE SEVERAL VIEWS OF THE DRAWINGS

These and other attributes of the invention will become more clear upon a thorough study of the following description of the best mode for carrying out the invention, particularly when reviewed in conjunction with the drawings, wherein:

FIG. 1 is a perspective view of one version of the multi-use file folder construction that forms the basis of this invention;

FIG. 2 is an isolated detail view of another version of the file folder construction with an end tab element removed; and,

FIG. 3 is another isolated detail view of the version depicted in FIG. 2 with an intermediate tab element removed.

### DETAILED DESCRIPTION OF THE INVENTION

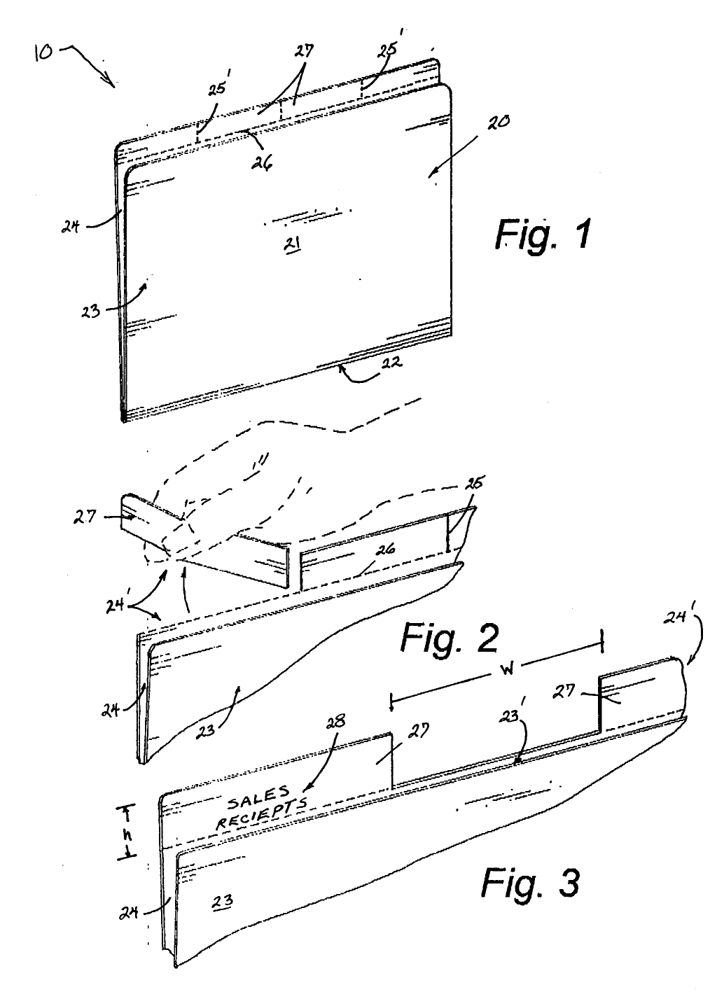

As can be seen by reference to the drawings, and in particular to FIG. 1, the multi-use file folder construction that forms the basis of the present invention is designated generally by the reference number 10. The construction 10 comprises in general a single sheet of material 20 such as heavy bond paper stock 21 that is provided with an offset crease line 22 that creates a generally rectangular front file face 23 and an enlarged rectangular rear file face 24.

As can be seen by reference to FIG. 2, in the first version of the preferred embodiment, the rear upper end 24′ of the file face 24 projects a selected distance above the upper end 23′ of the front file face 23 and is further provided with a first plurality of tab elements 26 the purpose and function of which will be described presently.

In addition, as shown in FIGS. 2 and 3, the upper end 24′ of the rear file face 24 is further provided with a horizontal line of perforations 26 that extends completely across the upper end 24′ of the rear file face 24 wherein, the line of perforation 26 intersects the bottom of the plurality of vertical slits 25 to allow the tab elements 27 to be selectively removed from the upper end 24′ of the rear file face 24.

At this juncture, it should be noted that each of the tab elements 27 has a height and width of a sufficient size for printed indicia 28 to be added by the end user to identify the current content of the file folder construction 10 wherein, the minimum width (w) of each tab element 27 will be 1″ and the minimum height (h) of each tab element 27 will be ¼ inch.

Returning one more time to FIG. 1, it can be seen that in the second version of the preferred embodiment, the upper end 24′ of the rear file face 24 is provided with a plurality of truncated vertical perforated lines 25′ in lieu of the vertical slits 25 depicted in FIGS. 2 and 3.

Although only an exemplary embodiment of the invention has been described in detail above, those skilled in the art will readily appreciate that many modifications are possible without materially departing from the novel teachings and advantages of this invention. Accordingly, all such modifications are intended to be included within the scope of this invention as defined in the following claims.

Having thereby described the subject matter of the present invention, it should be apparent that many substitutions, modifications, and variations of the invention are possible in light of the above teachings. It is therefore to be understood that the invention as taught and described herein is only to be limited to the extent of the breadth and scope of the appended claims.

I claim:

1. A multi-use file folder construction comprising a generally rectangular sheet of material having an offset crease forming a front file face and an enlarged rear file face having an upper end that projects above the front file face wherein, the upper end of the rear file face is provided with a transverse horizontal line of perforations and means extending upwardly from said horizontal line of perforations for defining a plurality of detachable tab elements.

2. The construction as in claim 1; wherein, said means for defining a plurality of detachable tab elements comprises
a plurality of spaced vertical slits in the upper end of the rear file face.

3. The construction as in claim 1; wherein, said means for defining a plurality of detachable tab elements comprises
a plurality of spaced vertical perforation lines in the upper end of the rear file face.

4. The construction as in claim 2; wherein, each tab element has a minimum width of 1 inch.

5. The construction as in claim 2; wherein, each tab element has a minimum height of ¼ inch.

6. The construction as in claim 4; wherein, each tab element has a minimum height of ¼ inch.

7. The construction as in claim 3; wherein, each tab element has a minimum width of 1 inch.

8. The construction as in claim 3; wherein, each tab element has a minimum height of ¼ inch.

9. The construction as in claim 7; wherein, each tab element has a minimum height of ¼ inch.
